(19) United States
(12) Patent Application Publication
(10) Pub. No.: US 2005/0077275 A1
(43) Pub. Date: Apr. 14, 2005

(54) Composite cutting with optical ablation technique

(76) Inventor: Richard Stoltz, Plano, TX (US)

Correspondence Address: CHALKER FLORES, LLP, 12700 PARK CENTRAL, STE. 455, DALLAS, TX, 75251, US

(21) Appl. No.: 10/957,272

(22) Filed: Oct. 1, 2004

Related U.S. Application Data
(60) Provisional application No. 60/510,855, filed on Oct. 14, 2003.

(51) Int. Cl. B23K 26/40

(52) U.S. Cl. 219/121.69

(57) ABSTRACT

The present invention relates to methods and systems for dynamically controlled laser amplifier configuration for composite cutting includes the steps of generating an initial wavelength-swept-with-time optical pulse in an optical pulse generator, amplifying the initial optical pulse, compressing the amplified optical pulse to a duration of less than 10 picoseconds and applying the compressed optical pulse on the composite with an ablating energy density, to controllably remove a slice of material from the composite.

### CROSS-REFERENCE TO RELATED APPLICATIONS

This application claims priority to U.S. Provisional Application: entitled “Composite Cutting With Optical Ablation Technique,” Ser. No. 60/510,855, filed Oct. 14, 2003 (Docket No. ABI-1026).

### TECHNICAL FIELD OF THE INVENTION

The present invention relates in general to the field of light amplification and, more particularly, a laser amplifier configuration for dynamically controlled composite cutting.

### BACKGROUND OF THE INVENTION

Heretofore in this field, ablative removal of material is generally done with a short optical pulse that is stretched amplified and then compressed. A number of types of laser amplifiers have been used for the amplification.

Laser machining can remove ablatively material by disassociate the surface atoms and melting the material. Laser ablation is efficiently done with a beam of short pulses (generally a pulse-duration of three picoseconds or less). Techniques for generating these ultra-short pulses (USP) are described, e.g., in a book entitled “Femtosecond Laser Pulses” (C. Rulliere, editor), published 1998, Springer-Verlag Berlin Heidelberg New York. Generally large systems, such as Ti:Sapphire, are used for generating ultra-short pulses (USP).

The USP phenomenon was first observed in the 1970's, when it was discovered that mode-locking a broad-spectrum laser could produce ultra-short pulses. The minimum pulse duration attainable is limited by the bandwidth of the gain medium, which is inversely proportional to this minimal or Fourier-transform-limited pulse duration. Mode-locked pulses are typically very short and will spread (i.e., undergo temporal dispersion) as they traverse any medium. Subsequent pulse-compression techniques are often used to obtain USP's. Pulse dispersion can occur within the laser cavity so that compression techniques are sometimes added intra-cavity. When high-power pulses are desired, they are intentionally lengthened before amplification to avoid internal component optical damage referred to as “Chirped Pulse Amplification” (CPA). The pulse is subsequently compressed to obtain a high peak power (pulse-energy amplification and pulse-duration compression).

### SUMMARY OF THE INVENTION

The method and system of the present invention provides a laser amplifier configuration for dynamically controlled composite cutting. The present invention cuts ablatively removing material by disassociating the surface atoms. The present invention may be used on a wide range of products that use composites as a result of the minimal-temperature rise, high-accuracy and minimal-pressure of the technique of the present invention.

Ablative material cutting with a short optical pulse is especially useful for cutting materials as it is essentially non-thermal. The method and system of the present invention uses controlled ultra-short pulse (generally sub-picosecond) optical ablation cutting of composite material (e.g., airplane or automobile fiber-reinforced-resin parts). The use of optical ablation material cutting allows the removal of any type of material (e.g., wood, plastic, metal, composite, polymers, fibers, carbon fiber, diamond and combinations thereof). The use of optical ablation material cutting can be preformed with minimal-temperature rise allowing cutting without releasing toxic fumes or creating heat related defects. The use of optical ablation material cutting also allows high-accuracy, as it avoids thermal effects during machining. Additionally, optical ablation material cutting produces minimal pressure avoiding the delamination of composite materials resulting from pressure. Furthermore, optical ablation material cutting uses a smaller beam producing a thinner cut than conventional methods (e.g., sawing) allowing a reduction in waste.

Unlike conventional machining, which melts portions of the work-piece, the present invention provides a method of material removal that is ablative, disassociating the molecules and ionizing their atoms. The present invention performs cutting of materials by removing the top few microns of the exposed surface with atoms expelled at high velocity. The ablated molecules are disassociated and atoms leave as ions. For efficient material removal, the pulse energy density is preferably dynamically controlled. Our control system developments now make ablative material cutting a practical manufacturing tool.

Cutting of composites, generally involves two or more materials that typically cut very differently (e.g., advanced composites boron or silicon carbide fibers and an epoxy resin). The different properties of the materials dictate the type of saw blades necessary to cut each material. Individually, such materials would normally be sawed with quite different saw blades and thus the normal sawing must be a compromise between the type of blades needed for each material and as such is a non-optimal blade. Ablation works well on any type material and thus any combination of materials can be easily and efficiently cut by the novel ablation technique of the present invention. Additionally, the characteristics of the ablation system allows a reduction in the propagation which results in defects in the material.

The present invention provides a method of cutting a composite, including generating an initial wavelength-swept-with-time optical pulse in an optical pulse generator, amplifying the initial pulse, compressing the amplified pulse to a duration of less than about 10 picoseconds, and applying the compressed optical pulse with an ablating energy density to the composite surface, to controllably remove a slice of material from the composite. The duration of the pulse may be varied between about 1 and 10 picoseconds. Other embodiments may have pulse durations less than about 1 picosecond. The ablating energy density to the composite surface may be between about 2 and 10 times optical ablation threshold of the material. The present invention provides the amplifying can be done with either a fiber-amplifier or a SOA (semiconductor optical amplifier). In some embodiments, two or more amplifiers are used in a train mode (e.g., pulses from one amplifier being delayed to arrive one or more nanoseconds after those from another amplifier) to give a rapid and controllable material ablation rate and/or the compressed optical pulse is applied to the surface.

As disclosed herein, dynamically controlled composite cutting can include at least one of the following: controlling of pulse energy density; cutting with material sensing of when the cutting has progressed to the far-side layer; cutting with material sensing of far-side ablation-stop-indicating tape or paint; cutting while sensing the distance to top surface to follow contour of the surface; sensing of a start-cutting marker and/or stop-cutting markers; following marker line on surface; following marker line on touch screen; following a numerically-controlled path; ablation cut-off when the distance to surface is out of a preset range (too close and/or too far away); electronic specifications and bookkeeping of cutting performed; and Auger composition measurements checked with material specifications (Auger-type material composition sensing can be done with high accuracy due to the avoiding of the normal Auger thermal distortions); and cutting with a beam at a generally non-perpendicular angle to avoid channeling. The composition measurements could be used, for example, to sense glue in tape placed on the far side of the composite, indicating that the cut was through the composite and the beam or composite should be stepped before resuming cutting.

As used herein, the term cutting includes cutting holes by ablating their periphery, rather than drilling holes and can include creation of non-circular holes. In one embodiment, the ablative cutting may be used to produce holes of varying size and shape. The present invention may also be used in conjunction with a non-ablative laser beam (e.g., after cutting), if some melting of the cut surface after cutting is desired. In some embodiments, the ablative cutting produces a series of closely spaced or partially overlapping conically shaped holes (e.g., of decreasing diameter with respect to depth), giving a perforated line along which the composite can be easily broken. The present invention allows the use of lines that are straight, however the line need not be straight. In such embodiments, the non-ablative laser can be used to soften material remaining to aid in the breaking, and/or to smooth the surface of the cut.

The present invention provides a method of cutting advanced composites, typically graphite and boron filaments in a cured resin (e.g., epoxy or vinyl-ester although other polymers and substances may be used) matrix, but this technique can be used on other types of composites, such as fiberglass and composites with polyester resin. Aluminum silicate and silicon carbide fiber can also be used. Conventional cutting using the normal sawing of an epoxy resin is quite different from sawing silicon carbide, however both ablate about the same. In some embodiments, the method of cutting advanced composites of the present invention, includes the cutting of composites having a foam core, e.g., of urethane or polyvinyl chloride. The present invention reducing the amount of heat produced in the cutting process which in turn reduces the amount of temperature related defects and toxic fumes produced. Urethane in particular, can emit toxic gases when cut by conventional methods. Often the composites a fiber-reinforced core layer with surface layers bonded on either side of the core layer.

As described herein, the use of ultra-short pulse optical ablation of the present invention avoids the stress-concentrating delamination that are thus prone to propagation, which frequently occurs during normal cutting. The optical cutting of the present invention may be done at eye-safe infrared wavelengths (e.g., about 1550 nm). The system provided by the present invention can also include material sensing during cutting, allowing sensing of when the cutting has progressed to the far-side layer and sensing of a start-cutting marker and/or stop-cutting markers.

Further, Auger-type material composition sensing can be done with high accuracy due to the avoiding of the normal Auger thermal distortions due to sidewall evaporation and similar thermal distortions. Optical ablation cutting can be done to a precise depth using material sensing of stop-indicating buried layer or stepped (or stopped) on sensing of material put on the far-side surface.

In the past, composites have been traditionally sawed or drilled. The present invention uses ablation to perform these functions. The present invention allows the removal of material in a line to give minimal-pressure ablation scribing. The line of material being removed may be of differing thickness and need not be a straight line or continuous line. The traditional sawing and drilling techniques can be done quickly, however they have also ruined a significant number of parts. Optical ablation on the other hand is fast and makes a smooth cut with limited stress-inducing downward or upward pressures and little strain induced in the composite.

The present invention also provides a method of cutting a composite including the steps of generating an initial wavelength-swept-with-time optical pulse in an optical pulse generator, amplifying the initial pulse, compressing the amplified pulse to a duration of less than 10 picoseconds and applying the compressed optical pulse to the composite surface to remove a slice of material from the composite. The beam can be scanned back and forth during the ablation scribing.

In the past, traditional methods generate significant heat during material removal, which can generate toxic gases depending on the material. Furthermore, a large number of fine particles have been generated. During optical ablative cutting, molecules are decomposed into atoms that leave as high velocity ions, removing even sub-micron particles (e.g., smaller than the wavelength of the light). In one embodiment, the optical ablation spot is rapidly scanned during cutting (e.g., back and forth over about a few mm path length at about 1,000 per second) by a piezoelectrically driven mirror. In other embodiments, the optical ablation spot is also advanced (e.g., in steps or continuously) relatively slowly by a motor driven stage. In some embodiments, the composition of material being removed is sensed, including wherein the composition of material being sensed is analyzed to determine when ablation reaches a predetermined layer. The predetermined layer may be a step-indication layer indicating that the spot should be stepped by the drive motor, a stop indicator layer indicating ablation is to be stopped when an indicator is reached.

In some embodiments, two or more amplifiers are used in a train mode (e.g., pulses from one amplifier being delayed to arrive one or more nanoseconds after those from another amplifier) to give a rapid and controllable material ablation rate, and/or the compressed optical pulse is applied to the surface in an ablation spot with an area between the areas of about 1 and 50 micron diameter circles. However, other embodiments may use a spot with an area less than a 1 micron diameter circles and still other embodiments may use a spot with an area greater than a 10 micron diameter circle. The use of one or more amplifiers in train mode allows step-wise control of ablation rate independent of pulse energy density. Embodiments in which a lower ablation rate is desired, one or more amplifiers can be shut down. Adjustments in the ablation rate allow more efficient ablation of a variety of materials with different ablation thresholds.

In one embodiment, the step of amplifying is done with a fiber-amplifier and the compressing is preformed with a air-path between gratings compressor combination. The initial pulses may be between about 10 picoseconds and 3 nanoseconds. The fiber amplifier may be an erbium-doped fiber amplifier and the air-path between gratings compressor may be a Treacy grating compressor. Additionally, two or more fiber amplifiers may be used with one compressor. In some embodiments, a chirped fiber compressor may be used for compressing the pulse.

The system of the present invention may be controlled such that pulse energy density and ablation rate are independently controlled and in other instances, pulse energy density, fiber amplifier operating temperature, and ablation rate are independently controlled.

### DETAILED DESCRIPTION OF THE INVENTION

The present invention provides a method for semiconductor manufacturing techniques using short pulse optical ablation configuration for dynamically controlled composite cutting. Cutting, as used herein includes cutting holes, including a composition-measuring hole. The optical ablation can be used on the wide range of products that use composites. Such products include airplanes, cars, motorcycles, truck cabs, motor home components (e.g., shower stalls and counter tops, dashboards, roof, front, rear and side wall panels), industrial tanks, and rail car liners, boats and golf carts.

The use of optical ablation of material cutting allows the removal of any type of material, and can do so with minimal-temperature rise, thus, cutting the material without releasing toxic gases. The present invention provides a method of cutting composites, involves two or more materials that typically cut very differently (e.g., advanced composites boron or silicon carbide fibers and an epoxy resin). The present invention also provides high-accuracy as it avoids thermal effects during machining, and cutting with minimal pressure avoids delamination of composite and loss of accuracy due to bending of parts during machining. The present invention also produces a cut thinner that traditional sawing, thus, reducing waste.

The optical ablation can also be used in a wide range of processing. Auger-type material composition sensing (e.g., sensing of electron-beam vaporized material being emitted from a material is known in materials analysis, the present invention uses an optical ablation beam, rather than the electron beam, for the vaporization) may be done with high accuracy due to the avoiding of the normal Auger thermal distortions. Optical ablation trench digging might be done to a precise depth using material sensing of stop-indication buried or internal layer. Ablative cutting removes a thin slice of material compared to that removed by conventional sawing and there is never a need to replace blades. In some embodiments, the composition of material being removed is sensed, including wherein the composition of material being sensed is analyzed to determine when ablation reaches a predetermined layer, indicating tape or paint. The layer may be a step-indication layer indicating that the spot should be stepped by the drive motor, a stop indicator layer indicating ablation is to be stopped when a is reached. In ablative cutting, the beam can be introduced at a generally perpendicular angle or non-perpendicular angle.

Composites are generally a macro scale combination of two or more solids having different mechanical properties. Major types of composites include fiber-reinforced plastics (e.g., having a core of either woven fibers or 5 to 20 mm long fiber whiskers bonded by a resin), and at least one fiber-free surface layer (e.g., a resin surface layer), or light-weight core/fiber reinforced resin/fiber-free surface layer types (e.g., a light-weight foam core, with woven fiber in resin layers on either side of the core, and fiber-free resin layers on the outer surfaces). The light-weight core can provide spacing between the fiber reinforced layers for structural purposes, but can also provide thermal or electrical insulation. It is anticipated that ablation systems will be used initially on the more expensive fiber-reinforced plastics composites (e.g., airplane tail sections, racing cars, etc.). In the future, ablation systems may well be used to machine (e.g., cut) other types of composites as well, such as laminates (generally having a core and veneers attached by an adhesive to the core surfaces), particle-filled composites (especially those with veneers), and cermets.

The present invention provides a system that can follow marker lines that are represented on a displayed, e.g., touch screen; follow marker pattern that are stored in memory; following a numerically-controlled path; cut ablation off when the distance to surface is out of a preset range (e.g., too close and/or too far away); perform electronic specifications and bookkeeping of cutting; and check Auger composition measurements with material specifications. Auger-type material composition sensing can be done with high accuracy due to the avoiding of the normal Auger thermal and sidewall distortions and cutting with an angled beam to avoid channeling. The novel manufacturing technique of the present invention uses short pulse optical ablation in cutting of composite surfaces for apparently the first time. The remaining material is essentially undamaged, avoiding stress-concentrating delaminations and even frayed ends on reinforcing fibers, and avoiding propagation of such flaws in the composite during later use.

The present invention provides a manufacturing technique using short optical pulses in ablation cutting of composite surfaces (e.g., advanced composites, polymers, fibers, metals and combinations thereof) for apparently the first time. The use of short optical pulses in ablation for material removal allows the removal of a thin slice of any type of material with minimal pressure and minimal temperature increase. The remaining material is essentially undamaged, avoiding stress-concentrating delaminations and even frayed ends on reinforcing fibers, thus avoiding propagation of such flaws in the composite, which can dramatically lower the strength of the composite. The present invention provides material cutting with minimal-temperature rise, minimal-pressure and ultra-high accuracy, thus, reducing thermal and bending effects during machining. In one application of the present invention ablation is preformed in a line to give minimal-pressure ablation to separate the composite into at least two pieces. Conventional methods of sawing materials induces chipping of the surface producing a rough surface, areas of high-stress-concentration and strains in the material, while optical ablation can produce a smooth cut surface and reduce the areas of high stress and strains in the material. High ablative pulse repetition rates are preferred and the total pulses per second (e.g., the total system repetition rate) from the one or more parallel optical amplifiers may be greater than about 0.6 million pulses per second.

For example, the use of a 1 nanosecond pulse with an optically-pumped pulse amplifier and air optical-compressor (e.g., a Treacy grating compressor) typically gives compression with about 40% losses. At less than about 1 nanosecond, the losses in a Treacy grating compressor are generally lower. If the other-than-compression losses are 10%, about 2 nanoJoules are needed from the amplifier to get 1 nanoJoule on the target. The present invention may use 1550 nm light for safety. The use of greater than 1 nanosecond pulse in an air optical-compressor presents two problems; the difference in path length for the extremes of long and short wavelengths needs to be more 3 cm and thus the compressor is large and expensive and the losses increase with a greater degree of compression. Other embodiments may use a chirped fiber Bragg gratings in place of the Treacy gratings for stretching and/or compressing.

The present invention may use a semiconductor generated initial pulse. In some embodiments, a semiconductor optical amplifier (SOA) preamplifier is used to amplify the initial pulse before splitting to drive multiple amplifiers. In instances where a larger spot is desired, the ablation of a smaller may be scanned to get a larger effective ablation area. Some embodiments using a SOA amplifier result in the beam spot on the composite surface that is smaller than the above fiber-amplifier cases.

Ablative material removal often has an ablation threshold of less than about 1 Joule per square centimeter, but can require removal of material with an ablation threshold of up to about 2 Joules per square centimeter. In other embodiments, energy density may be less than about two (2) times the ablation thresholds of the material being ablated or the energy density may be greater than about 10 times the ablation thresholds of the material being ablated. Preferably, the system is operated with pulse energy densities on the surface of about three times the materials ablation threshold for greater ablation efficiency. The ablating energy density is dynamically adjusted in some embodiments based on Auger-type composition measurements of the composition of the material being ablated.

Some embodiments of the present invention use parallel amplifiers that allows the generation of a train of pulses and increases the ablation rate by further increasing the effective repetition rate, while avoiding thermal problems in the amplifier and allowing control of ablation rate by the use of a variable number of operating amplifiers. The use of two or more amplifiers in parallel train mode with pulses from one amplifier being delayed to arrive one or more nanoseconds after those from another amplifier is preferred in some embodiments. At lower desired powers, one or more amplifiers can be shut off (e.g., by stopping the optical pumping of optically-pumped pulse amplifiers), and there will be fewer pulses per train. For example, 20 amplifiers would produce a maximum of 20 pulses in a train, but many uses might use only three or four amplifiers and three or four pulses per train.

Generally, the optically-pumped pulse amplifiers are optically-pumped continuous wave (CW) and are amplifying perhaps 100,000 times per second in 1 nanosecond pulses. Alternately, non-CW-pumping might be used in operating amplifiers, with amplifiers run in a staggered fashion, e.g., one on for a first half-second period and then turned off for a second half-second period, and another amplifier, dormant during the first-period, turned on during the second period, and so forth, to spread the heat load. In some embodiments of the present invention the input optical signal power into the optical amplifier, optical pumping power of optically-pumped pulse amplifiers, timing of input pulses, length of input pulses, and timing between start of optical pumping and start of optical signals into the optical amplifier to control pulse power, and the average degree of energy storage in fiber can be controlled.

Many optically-pumped pulse amplifiers have a maximum power of 4 MW, and thus a 10-microJoule-ablation pulse could be as short as 2 picoseconds. Thus, a 10 picosecond, 10 microjoule pulse, at 500 kHz (or 50 microjoule with 100 kHz). The system of the present invention may be operated in a train mode and switching optically-pumped pulse amplifiers in instances where heating becomes a problem. Thus, a system may rotate the running of ten optically-pumped pulse amplifiers such that only five were operating at any one time (e.g., each on for 1/10^{th} of a second and off for 1/10^{th} of a second). Again the system can have ten optically-pumped pulse amplifiers with time spaced inputs, e.g., by 1 nanoseconds, to give a train of one to 10 pulses. In one example, 5 W amplifiers operating at 100 kHz (and e.g., 50 microjoules) allowing stepping of between 100 kHz and 1 MHz. With 50% post-amplifier optical efficiency and 50 microjoules, to get 6 Joule per square centimeter on the target, the spot size could be about 20 microns. In another example, 5 W amplifiers operating at 20 kHz (and e.g., 250 microjoules) and with 10 optically-pumped pulse amplifiers allowing stepping of between 20 kHz and 200 kHz. With 50% post-amplifier optical efficiency and 250 microjoules, to get 6 Joule per square centimeter on the target, the spot size would be about 50 microns. The amplified pulse might be 100 to 250 picoseconds long. A similar system with 30 optically-pumped pulse amplifiers could step between 20 kHz and 600 kHz.

Generally the pulse generator controls the input repetition rate of the optically-pumped pulse amplifiers to tune energy per pulse to about three times threshold per pulse. Another alternative to control the input repetition rate is generating a sub-picosecond pulse and time-stretching that pulse within semiconductor pulse generator to give the wavelength-swept-with-time initial pulse for the optically-pumped pulse amplifier. Another alternate to control the input repetition rate is to measure light leakage from the delivery fiber to get a feedback proportional to pulse power and/or energy for control purposes.

Optically-pumped optical pulse amplifiers, including those used to pump other optical devices, in general may have a variety of shapes (e.g., slabs, discs, and rods) and can be controlled as in co-pending provisional applications. The lamp-pumping can be controlled by controlling the pumping lamps in a manner similar to that of controlling pump diode current. In one embodiment, diode pump-current is used to control the amplification of an active mirror. Generally, the optical pump device (e.g., diode or lamp) current is controlled either directly or indirectly by controlling voltage, power and/or energy. As used herein, controlling current can include shutting off one or more optical pump devices, when multiple pump devices are used.

These optical amplifiers can be in systems described, operated, controlled, and/or used in systems in generally the same manner as the fiber amplifier of the four co-pending and co-owned applications noted below by docket number, title and provisional number, were filed May 20, 2003 and are hereby incorporated by reference herein: Docket number ABI-1 Laser Machining provisional application number 60/471,922; ABI-4 “Camera Containing Medical Tool” provisional application number 60/472,071; ABI-6 “Scanned Small Spot Ablation With A High-Rep-Rate” provisional application number 60/471,972; ABI-7 “Stretched Optical Pulse Amplification and Compression”, provisional application number 60/471,971. These amplifiers can be controlled and/or used in systems in generally the same manner as the fiber amplifier of the eleven co-pending applications noted below by docket number, title and provisional number, were filed Aug. 11, 2003 and are hereby incorporated by reference herein: ABI-8 “Controlling Repetition Rate Of Fiber Amplifier” provisional application number 60/494,102; ABI-9 “Controlling Pulse Energy Of A Fiber Amplifier By Controlling Pump Diode Current” provisional application number 60/494,275; ABI-10 “Pulse Energy Adjustment For Changes In Ablation Spot Size” provisional application number 60/494,274; ABI-11 “Ablative Material Removal With A Preset Removal Rate or Volume or Depth” provisional application number 60/494,273; ABI-12 “Fiber Amplifier With A Time Between Pulses Of A Fraction Of The Storage Lifetime”; ABI-13 “Man-Portable Optical Ablation System” provisional application number 60/494,321; ABI-14 “Controlling Temperature Of A Fiber Amplifier By Controlling Pump Diode Current” provisional application number 60/494,322; ABI-15 “Altering The Emission Of An Ablation Beam for Safety or Control” provisional application number 60/494267; ABI-16 “Enabling Or Blocking The Emission Of An Ablation Beam Based On Color Of Target Area” provisional application number 60/494,172; ABI-17 “Remotely-Controlled Ablation of Surfaces” provisional application number 60/494,276 and ABI-18 “Ablation Of A Custom Shaped Area” provisional application number 60/494,180. These amplifiers can be controlled and/or used in systems in generally the same manner as the fiber amplifier of the co-pending provisional application noted below by docket number and, title that was filed on Sep. 12, 2003: co-owned ABI-20 “Spiral-Laser On-A-Disc” inventor, Richard Stoltz.

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method of removing a material from a composite comprising the steps of:
generating an initial wavelength-swept-with-time optical pulse in an optical pulse generator;
amplifying the initial optical pulse;
compressing the amplified optical pulse to a duration of less than 10 picoseconds; and
applying the compressed optical pulse on the composite with an ablating energy density, to controllably remove a slice of material from the composite.

2. The method of claim 1, wherein the composite has graphite or boron filaments in a cured resin.

3. The method of claim 1, wherein the step of amplifying is done with either a fiber-amplifier or a SOA.

4. The method of claim 1, wherein the ablation is done in a line to give minimal-pressure ablation to separate the composite into two or more pieces and the cutting is with a beam at a non-perpendicular angle.

5. The method of claim 1, wherein the ablating energy density of the ablation pulse is controlled.

6. The method of claim 1, wherein the composition of material being removed is sensed.

7. The method of claim 6, wherein the composition of material being sensed is analyzed to determine when the ablation reaches a step-indicator.

8. The method of claim 5, wherein the energy density on the surface is between about 2 and 10 times the optical ablation threshold of the surface.

9. The method of claim 1, wherein two or more optical amplifiers are used in a train mode.

10. The method of claim 1, wherein the compressed optical pulse is applied to the composite in a generally circular spot with an area between about 1 and 50 micron in diameter.

11. The method of claim 1, wherein the amplifying and compressing is done with a fiber-amplifier and air-path between gratings compressor combination, the initial pulses are between about 10 picoseconds and 3 nanoseconds and the compressed optical pulse has a sub-picosecond duration.

12. The method of claim 1, wherein the controlling is by dynamically controlling is by at least one of: controlling of pulse energy density; cutting with material composition sensing indicating when the cutting has progressed to a far-side layer; cutting with material composition sensing of far-side ablation-stop-indicating tape or paint; cutting while sensing the distance to top surface to follow contour of the surface; sensing of a start-cutting marker and/or stop-cutting markers; following marker line on surface; following marker line on a touch screen; following a numerically-controlled path; and ablation cut-off when the distance to surface is out of a preset range.

13. The method of claim 11, wherein the air-path between gratings compressor is a Treacy grating compressor.

14. The method of claim 1, wherein two or more fiber amplifiers are used in a train mode and with one compressor.

15. The method of claim 10, wherein the compressing is done with a chirped fiber compressor.

16. The method of claim 11, wherein the fiber amplifier is an erbium-doped fiber amplifier.

17. The method of claim 1, wherein pulse energy density and ablation rate are independently controlled.

18. The method of claim 1, wherein pulse energy density, fiber amplifier operating temperature, and ablation rate are independently controlled.

19. The method of claim 10, wherein the spot is scanned by a piezoelectrically driven mirror.

20. A method of cutting a composite, comprising the steps of:
generating an initial wavelength-swept-with-time optical pulse in an optical pulse generator;
amplifying the initial pulse;
compressing the amplified pulse to a duration of less than about 10 picoseconds; and
applying the compressed optical pulse with an ablating energy density to the composite to remove a slice of material from the composite.
